(19) United States
(12) Patent Application Publication
(10) Pub. No.: US 2023/0036751 A1
(43) Pub. Date: Feb. 2, 2023

(54) SPARSE MEMORY HANDLING IN POOLED MEMORY

(71) Applicant: Intel Corporation, Santa Clara, CA (US)

(72) Inventors: Francesc Guim Bernat, Barcelona (ES); Karthik Kumar, Chandler, AZ (US); Thomas J. Willhalm, Sandhausen (DE)

(73) Assignee: Intel Corporation, Santa Clara, CA (US)

(21) Appl. No.: 17/958,223

(22) Filed: Sep. 30, 2022

(51) Int. Cl. G06F 12/0815; G06F 12/06

(52) U.S. Cl. CPC G06F 12/0815; G06F 12/063

(57) ABSTRACT

A network processing device identifies a first request to access a line of memory in a remote memory resource and determines, based on the address of the line of memory, that the line of memory is associated with a sparse region in a memory pool. The address is provided as an input to a probabilistic data structure, where the probabilistic data structure is to generate a result to identify whether the line of memory includes a common data pattern. The network processing device returns the common data pattern as a response to the first request if the result of the probabilistic data structure indicates that the first line of memory includes the common data pattern.

### FIELD

The present disclosure relates in general to the field of distributed computing systems, and more specifically, to data transfers within data center clusters.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2A illustrates a simplified block diagram of an example computing system utilizing a link compliant with a Compute Express Link (CXL)-based protocol.

FIG. 2B illustrates a simplified block diagram of example protocol circuitry.

FIGS. 3A-3C are simplified block diagrams illustrating example device types within a Compute Express Link (CXL) infrastructure.

FIG. 4 is a simplified block diagram illustrating memory pooling using a CXL protocol.

FIG. 5 is a simplified block diagram illustrating an example data center cluster architecture.

FIG. 6 is a simplified block diagram illustrating data transfers within an example data center cluster architecture.

FIG. 7 is a representation of dense and sparse matrices.

FIG. 8 is a simplified block diagram illustrating an example system implementing a memory pool among multiple computing platforms.

FIG. 9 is a simplified block diagram illustrating an example computing platform with a network processing device.

FIG. 10 is a simplified block diagram illustrating an example network processing device.

FIG. 11 is a simplified flow diagram illustrating an example technique for accessing a sparse memory region.

FIG. 12 illustrates a block diagram of an example processor device in accordance with certain embodiments.

Like reference numbers and designations in the various drawings indicate like elements.

### DETAILED DESCRIPTION

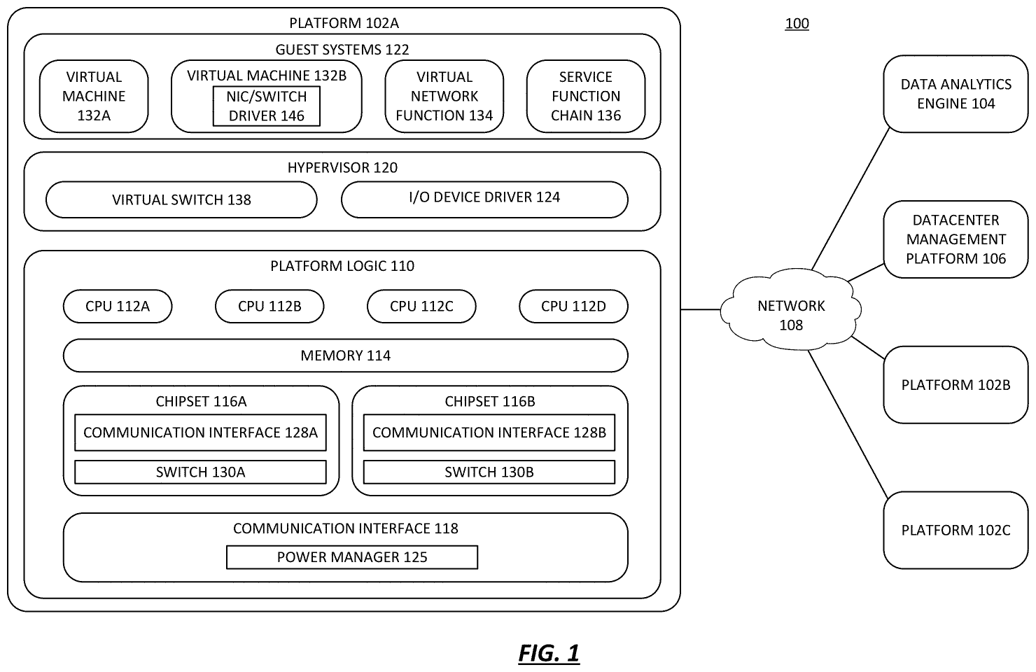

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chip sets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniB and, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

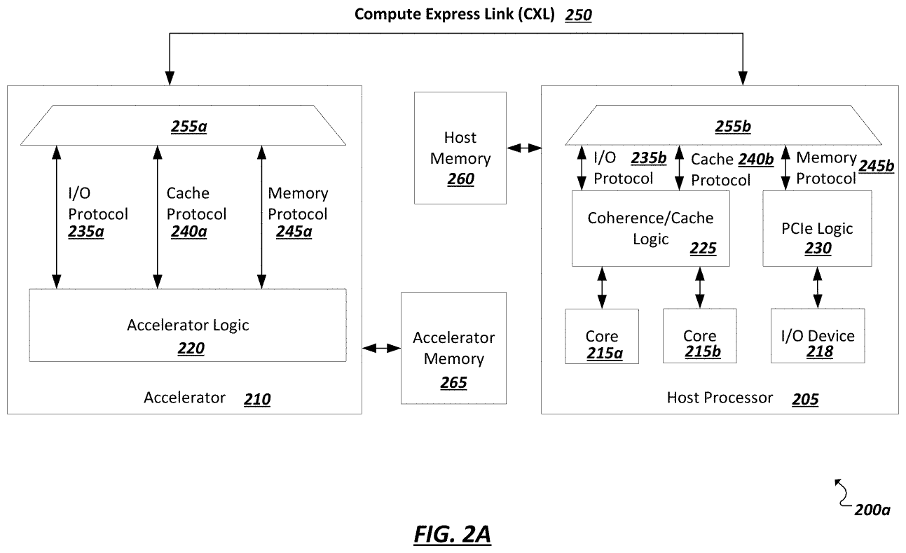

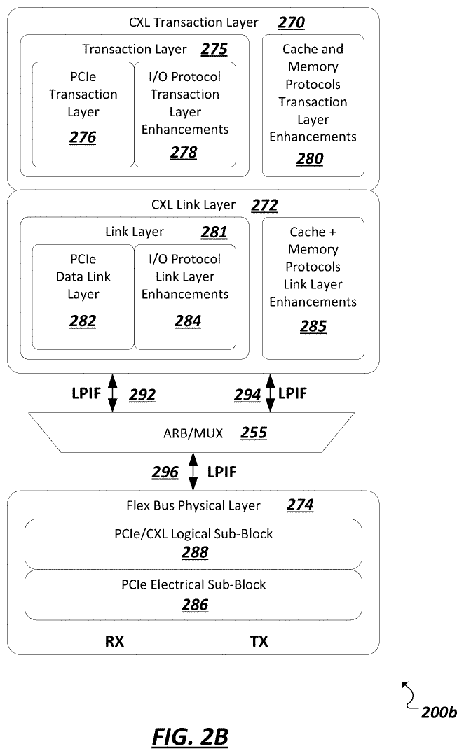

FIGS. 2A-2B are simplified block diagrams illustrating example protocol logic, implemented in hardware and/or software, to implement a Compute Express Link (CXL) protocol. It should be appreciated, that while much of the discussion centers on features provided by a CXL-protocol and communication channels compliant with CXL, that other substitute protocols with similar, comparable features may be substituted for CXL in the embodiments discussed below. The CXL interconnect protocol is designed to provide an improved, high-speed CPU-to-device and CPU-to-memory interconnect designed to accelerate next-generation data center performance, among other application. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, networking accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of sub-protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0), leveraging the PCIe physical and electrical interface to provide advanced protocol in areas include I/O , memory protocol (e.g., allowing a host processor to share memory with an accelerator device), and coherency interface.

Turning to FIG. 2A, a simplified block diagram 200a is shown illustrating an example system utilizing a CXL link 250. For instance, the link 250 may interconnect a host processor 205 (e.g., CPU) to an accelerator device 210. In this example, the host processor 205 includes one or more processor cores (e.g., 215a-b) and one or more I/O devices (e.g., 218). Host memory (e.g., 260) may be provided with the host processor (e.g., on the same package or die). The accelerator device 210 may include accelerator logic 220 and, in some implementations, may include its own memory (e.g., accelerator memory 265). In this example, the host processor 205 may include circuitry to implement coherence/cache logic 225 and interconnect logic (e.g., PCIe logic 230). CXL multiplexing logic (e.g., 255a-b) may also be provided to enable multiplexing of CXL protocols (e.g., I/O protocol 235a-b (e.g., CXL.io), caching protocol 240a-b (e.g., CXL.cache), and memory access protocol 245a-b (CXL.mem)), thereby enabling data of any one of the supported protocols (e.g., 235a-b, 240a-b, 245a-b) to be sent, in a multiplexed manner, over the link 250 between host processor 705 and accelerator device 210.

In some implementations, a Flex Bus™ port may be utilized in concert with CXL-compliant links to flexibly adapt a device to interconnect with a wide variety of other devices (e.g., other processor devices, accelerators, switches, memory devices (e.g., near memory, far memory, pooled memory, tiered memory, cache, etc.), among other examples). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

FIG. 2B is a simplified block diagram 200b illustrating an example protocol stack and associated logic (implemented in hardware and/or software) utilized to implement CXL links. For instance, the protocol logic may be organized as multiple layers to implement the multiple protocols supported by the port. For instance, a port may include transaction layer logic (e.g., 270), link layer logic (e.g., 272), and physical layer logic (e.g., 274) (e.g., implemented all or in-part in circuitry). For instance, a transaction (or protocol) layer (e.g., 270) may be subdivided into transaction layer logic 275 that implements a PCIe transaction layer 276 and CXL transaction layer enhancements 278 (for CXL.io) of a base PCIe transaction layer 276, and logic 280 to implement cache (e.g., CXL.cache) and memory (e.g., CXL.mem) protocols for a CXL link. Similarly, link layer logic 272 may be provided to implement a base PCIe data link layer 282 and a CXL link layer (for CX1.io) representing an enhanced version of the PCIe data link layer 284. A CXL link layer 272 may also include cache and memory link layer enhancement logic 285 (e.g., for CXL.cache and CXL.mem).

Continuing with the example of FIG. 2B, a CXL link layer logic 272 may interface with CXL arbitration/multiplexing (ARB/MUX) logic 255, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 274 based on a PCIe physical layer (e.g., PCIe electrical PHY 286). For instance, a Flex Bus physical layer may be implemented as a converged logical physical layer 288 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port may be fully compliant with native PCIe features (e.g., as defined in the PCIe specification), while in CXL mode, the link supports all features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that each have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transaction involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Master and the Mem device is regarded as the CXL.mem Subordinate. The CXL.mem Master is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 272) to circuitry or other logic (e.g., an IP block or other hardware element) implementing at least a portion of a physical layer (e.g., 274) of a protocol. For instance, an interface based on a Logical PHY Interface (LPIF) specification to define a common interface between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 2B. Additionally, as in the example of FIG. 2B, an interface may be implemented with logic (e.g., 281, 285) to simultaneously implement and support multiple protocols. Further, in such implementations, an arbitration and multiplexer layer (e.g., 255) may be provided between the link layer (e.g., 272) and the physical layer (e.g., 274). In some implementations, each block (e.g., 255, 274, 281, 285) in the multiple protocol implementation may interface with the other block via an independent interface (e.g., 292, 294, 296). In cases where bifurcation is supported, each bifurcated port may likewise have its own independent interface, among other examples.

CXL is a dynamic multi-protocol technology designed to support accelerators and memory devices. CXL provides a rich set of protocols. CXL.io is for discovery and enumeration, error reporting, peer-to-peer (P2P) accesses to CXL memory and host physical address (HPA) lookup. CXL.cache and CXL.mem protocols may be implemented by various accelerator or memory device usage models. An important benefit of CXL is that it provides a low-latency, high-bandwidth path for an accelerator to access the system and for the system to access the memory attached to the CXL device. The CXL 2.0 specification enabled additional usage models, including managed hot-plug, security enhancements, persistent memory support, memory error reporting, and telemetry. The CXL 2.0 specification also enables single-level switching support for fan-out as well as the ability to pool devices across multiple virtual hierarchies, including multi-domain support of memory devices. The CXL 2.0 specification also enables these resources (memory or accelerators) to be off-lined from one domain and on-lined into another domain, thereby allowing the resources to be time-multiplexed across different virtual hierarchies, depending on their resource demand. Additionally, the CXL 3.0 specification doubled the bandwidth while enabling still further usage models beyond those introduced in CXL 2.0. For instance, the CXL 3.0 specification provides for PAM-4 signaling, leveraging the PCIe Base Specification PHY along with its CRC and FEC, to double the bandwidth, with provision for an optional flit arrangement for low latency. Multi-level switching is enabled with the CXL 3.0 specification, supporting up to 4K Ports, to enable CXL to evolve as a fabric extending, including non-tree topologies, to the Rack and Pod level. The CXL 3.0 specification enables devices to perform direct peer-to-peer accesses to host-managed device memory (HDM) using Unordered I/O (UIO) (in addition to memory-mapped I/O (MMIO)) to deliver performance at scale. Snoop Filter support can be implemented in Type 2 and Type 3 devices to enable direct peer-to-peer accesses using the back-invalidate channels introduced in CXL.mem. Shared memory support across multiple virtual hierarchies is provided for collaborative processing across multiple virtual hierarchies, among other example features.

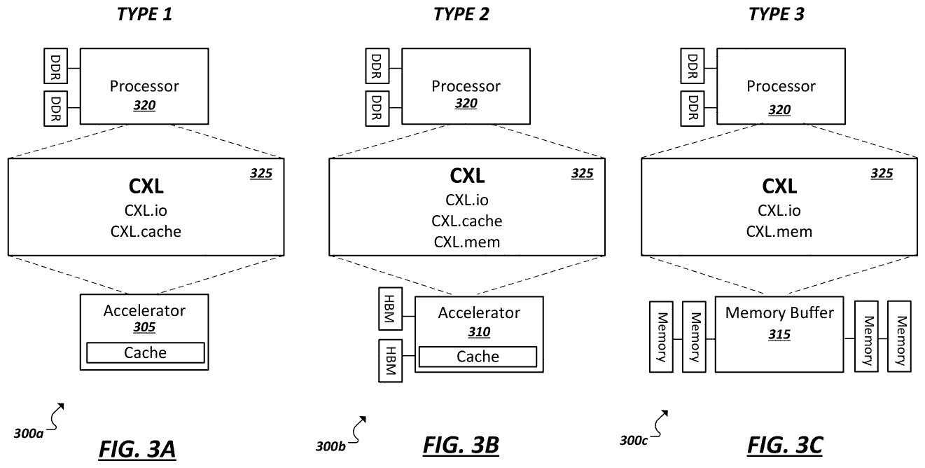

CXL is a high-performance I/O bus architecture that is used to interconnect peripheral devices that can be either traditional non-coherent I/O devices, memory devices, or accelerators with additional capabilities. When Type 2 and Type 3 device memory is exposed to the host, it is referred to as Host-managed Device Memory (HDM). The coherence management of this memory may be Host-only Coherent (HDM-H), Device Coherent (HDM-D), and Device Coherent using Back-Invalidation Snoop (HDM-DB). The host and device must have a common understanding of the type of HDM for each address region. FIGS. 3A-3C are simplified block diagrams 300a-c showing examples of CXL Type 1 devices (e.g., 305), Type 2 devices (e.g., 310), and Type 3 devices (e.g., 315). A CXL device (e.g., 305, 310, 315) may couple to a host processor (e.g., 320) via a CXL interconnect 325. Different CXL device types may utilize different combinations of the CXL protocols (or sub-protocols) (e.g., CXL.io, CXL.mem, CXL.cache).

In CXL, a “Type 1” devices have special needs for which having a fully coherent cache in the device becomes valuable. For such devices, standard producer-consumer ordering models do not work well. One example of a device with special requirements is to perform complex atomics that are not part of the standard suite of atomic operations present on PCIe. Basic cache coherency allows an accelerator to implement any ordering model it chooses and allows it to implement an unlimited number of atomic operations. These tend to require only a small capacity cache which can easily be tracked by standard processor snoop filter mechanisms. The size of cache that can be supported for such devices depends on the host's snoop filtering capacity. CXL supports such devices using its optional CXL.cache link over which an accelerator can use CXL.cache protocol for cache coherency transactions.

CXL “Type 2” devices, in addition to fully coherent cache, also have memory, for example DDR, High-Bandwidth Memory (HBM), or other memory attached to the device. These devices execute against memory, but their performance comes from having massive bandwidth between the accelerator and device-attached memory. One goal for CXL is to provide a means for the Host to push operands into device-attached memory and for the Host to pull results out of device-attached memory such that it does not add software and hardware cost that offsets the benefit of the accelerator. Systems may include coherent system address-mapped device-attached memory, also referred to as HDM with Device Managed Coherence (HDM-D/HDM-DB). There is an important distinction between HDM and traditional I/O and PCIe Private Device Memory (PDM). An example of such a device is a GPGPU with attached GDDR. Such devices have treated device-attached memory as private. This means that the memory is not accessible to the Host and is not coherent with the remainder of the system. It is managed entirely by the device hardware and driver and is used primarily as intermediate storage for the device with large data sets. A disadvantage to a model such as this is that it involves high-bandwidth copies back and forth from the Host memory to device-attached memory as operands are brought in and results are written back. Please note that CXL does not preclude devices with PDM.

At a high level, there are two example approaches of resolving device coherence of HDM. The first uses CXL.cache to manage coherence of the HDM and is referred to as “Device coherent.” The memory region supporting this flow is indicated with the suffix of “D” (HDM-D). The second approach uses the dedicated channel in CXL.mem called Back Invalidation Snoop and is indicated with the suffix “DB” (HDM-DB). With HDM-DB, the protocol enables new channels in the CXL.mem protocol that allow direct snooping by the device to the host using a dedicated Back-Invalidation Snoop (BISnp) channel. The response channel for these snoops is the Back-Invalidation Response (BIRsp) channel. The channels allow devices the flexibility to manage coherence by using an inclusive snoop filter tracking coherence for individual cache lines that may block new M2S Requests until BISnp messages are processed by the host.

A CXL “Type 3” device supports CXL.io and CXL.mem protocols. An example of a CXL Type 3 Device is a memory expander for the Host. Since this is not a traditional accelerator that operates on host memory, the device does not make any requests over CXL.cache. A passive memory expansion device would use the HDM-H memory region and while not directly manipulating its memory while the memory is exposed to the host. The device operates primarily over CXL.mem to service requests sent from the Host. The CXL.io protocol is used for device discovery, enumeration, error reporting and management. The CXL.io protocol is permitted to be used by the device for other I/O-specific application usages. The CXL architecture is independent of memory technology and allows for a range of memory organization possibilities depending on support implemented in the Host. Type 3 device Memory that is exposed as an HDM-DB enables the device to directly manage coherence with the host to enable in-memory computing and direct access using UI0 on CXL.io. A Type 3 Multi-Logical Device (MLD) can partition its resources into up to multiple (e.g., 16) isolated Logical Devices. Each Logical Device may be identified by a Logical Device Identifier (LD-ID) in CXL.io and CXL.mem protocols. Each Logical Device visible to a Virtual Hierarchy (VH) operates as a Type 3 device. The LD-ID is transparent to software. MLD components have common Transaction and Link Layers for each protocol across all LDs.

CXL is capable of maintaining memory coherency between the CPU memory space and memory on attached devices, so that any of the CPU cores or any of the other I/O devices configured to support CXL may utilize these attached memories and cache data locally on the same. Further, CXL allows resource sharing for higher performance, such that memory pooling may be achieved across different computing entities. Such CXL-enabled memory pools may enable enhanced and more efficient movement of operands. For instance, rather than utilizing DMA operation to transfer an entire segment of data from one computing element to the next computing element in association with a corresponding operation, coherent memory allows data to be moved seamlessly as if it were a simple transfer between the different cores in different CPU sockets. Such memory pooling can thus realize significant latency reduction and enable this aggregated memory in the system. Such features can enable more efficient memory usage, reduced architectural complexity, and thereby lower overall system costs. Further, such features allows programmers and system developers to focus on target workloads as opposed to redundant memory management, among other example benefits.

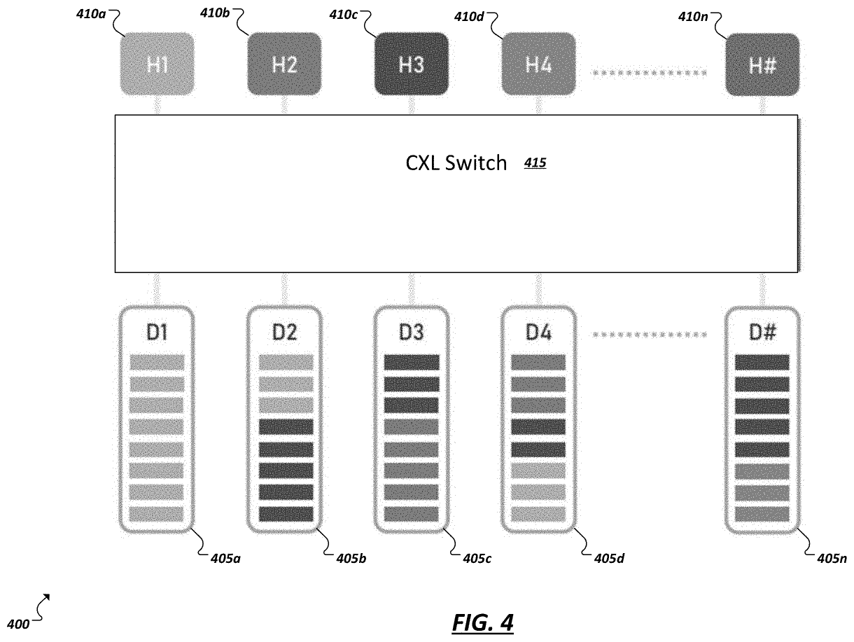

FIG. 4 is a simplified block diagram 400 illustrating the example pooling of multiple devices 405a-n (e.g., logical type 2 devices) to multiple host devices 410a-m. CXL (e.g., CXL 2.0) enables such pooling utilizing a CXL switch 415 (with a standardized CXL Fabric manager 418), where the memory on the devices 405a-n can be assigned to or shared with different hosts (e.g., 410a-m) and can be changed over time. The CXL switch 415 supports multiple hosts and is responsible for ensuring quality of service as well as isolation between different hosts. Other implementations, may utilize processing-in-memory (PIM) within their systems or cluster, including logic-in-memory or near-data processing. PIM technology aims to bring memory and computing closer instead of separating them, thus, improving the efficiency of data movement. Traditional PIM systems, however, may struggle with data coherence issues, as both a host processor and PIM processing can handle and compete for data, among other example issues.

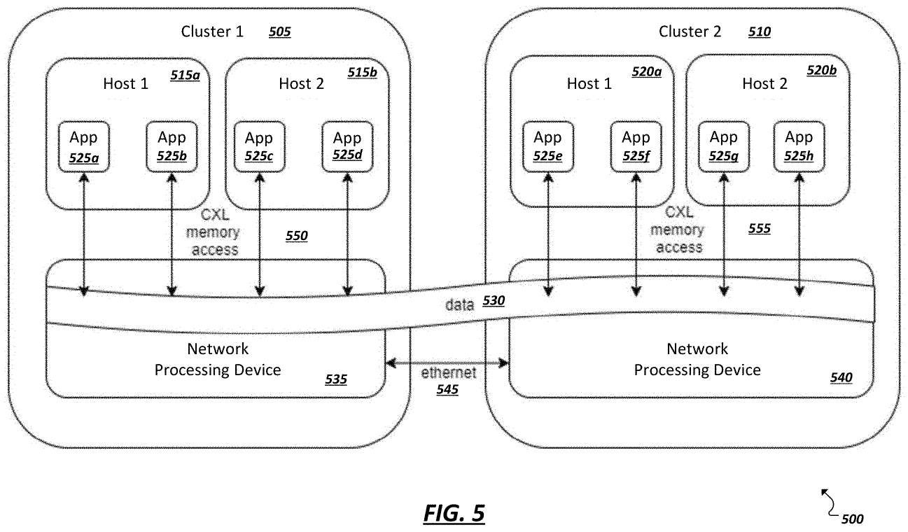

Improved node or cluster architectures may leverage the combined features of CXL and smart network processing devices (e.g., IPUs) to develop more efficient and better-performing service mesh clusters, which achieve these efficiencies with minimal movement of networking data and enhanced near memory processing. Such improved clusters can realize smaller latency, better resources utilization, and lower power consumption, among other example benefits. FIG. 5 is a simplified block diagram 500 illustrating a logical view of such a portion of such an improved cluster. As introduced above, a service mesh can be composed of one or multiple clusters (e.g., 505, 510). Host devices (e.g., 515a, 515b, 520a, 520b, etc.) may each host various programs, services, or applications (e.g., 525a-h), which are executed on the corresponding host and which may share and operate various data on the service mesh. All of the data 530 moving within the cluster may be handled using the corresponding cluster's network processing device (e.g., 535, 540), with the network processing device further handling the inter-cluster communications and the internal connections of hosts and the network processing device within the cluster. Attached memory of the network processing device may be utilized to implement a memory pool for the cluster. Accordingly, data used in transactions within the cluster may be saved in the memory pool on the network processing device. Accordingly, when host device accesses the data within a transaction, the host device can utilize CXL memory accesses (e.g., 550, 555) to directly read or write data through the CXL cached memory as if it were local memory.

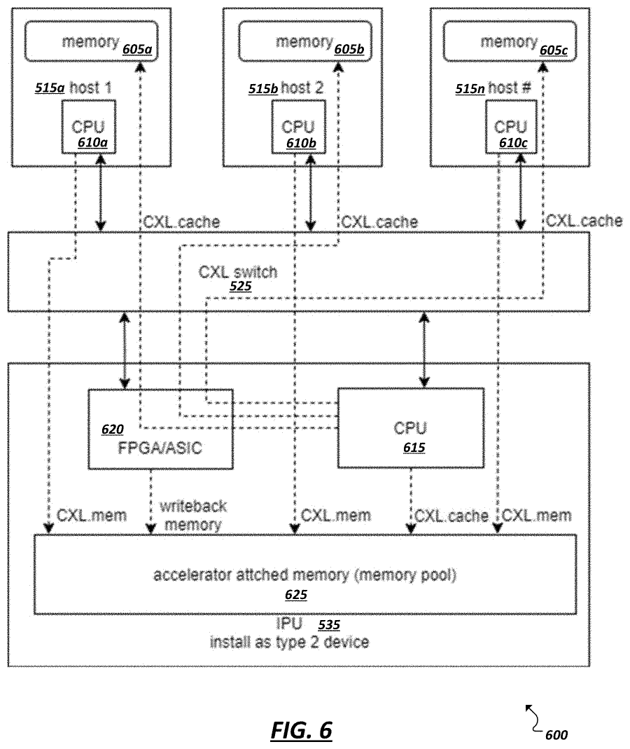

Turning to FIG. 6, a simplified block diagram 600 illustrating example hardware blocks of components within a cluster, such as the example shown in FIG. 5. For instance, each host device (e.g., 515a-n) may include respective local or attached memory (e.g., 605a-c) as well respective processing hardware 610a-c (e.g., CPU, FPGA, GPU, tensor processing unit (TPU), accelerator hardware, etc.), which may be utilized to host and execute various applications or portions of applications on the corresponding host. Each of the host devices 515a-c may be connected to a CXL switch 525 for the cluster. The network processing device 535 of the cluster is also coupled to the switch 525. The network processing device 535 may include both a CPU 615 and programmable processing block 620 (e.g., a field programmable gate array (FPGA) or application-specific integrated circuit (ASIC)), together with attached memory 625, at least a portion of which is designated for use as a memory pool for the cluster.

In one example implementation, the network processing device 535 may be installed as a CXL type 2 device. Accordingly, the CPUs (e.g., 610a-c) of the hosts 515a-c, as well as the CPU (e.g., 615) of the network processing device 535, can cache (e.g., perform cacheable reads and cacheable writes of) the attached memory of the network processing device 535 using the CXL.mem subprotocol. The programmable processing block 620 of the network processing device 535 may cache the hosts' attached memory (e.g., 605a-c) using the CXL.cache subprotocol. Further, a dedicated hardware channel may be provided between the CPU 615 and programmable processing block 620 of the network processing device 535, allowing the CPU 615 to access the hosts' memories (e.g., 605a-c) through the programmable processing block 620 (e.g., also using the CXL.cache subprotocol), among other example features and implementations.

Data centers and data center networks continue to grow in prevalence and performance capabilities as cloud computing and other distributed computing architectures and systems grow in prevalence. With data center network speeds reaching 100Gps and continuing to increase, conventional communication protocols may not be able to keep pace. For instance, the transmission control protocol (TCP) cannot provide the performance that cloud service providers need or desire to provide their respective services (e.g., infrastructure as a service (IaaS), software as a service (SaaS), platform as a service (PaaS), etc.). For instance, TCP is not generally suited for latency sensitive processing due to its congestion management and retransmission control features. Further, data movement between memory, processors, and I/O devices struggle to meet the demands of memory intensive applications using traditional protocols.

Workloads handled by distributed computing architectures also continue to evolve. New workloads and applications challenge traditional data center assumptions and architectures. As an example, the increasing popularity of and innovations pertaining to machine learning, artificial intelligence, and training machine learning models and hardware used in such applications have spurred the development of new computing architectures to handle corresponding workloads. Cloud computing and data center environments have been targeted to handle such workloads and the corresponding data. However, evolving machine learning and tensor processing workloads may be vastly different workloads and require processing and memory infrastructure divergent from that relied upon to handle other more traditional applications, among other example issues.

In an improved system implementation, a data center cluster may be implemented utilizing the CXL-based communication channels. For instance, a CXL-based data center cluster (also referred to herein as “nodes” or “platforms”) may include a number of host computers coupled to a CXL-based switch or network processing device. Traffic within the cluster and between clusters may be implemented utilizing a network processor device (e.g., a smart network interface controller (NIC), data processing unit (DPU), infrastructure processing unit (IPU), programmable networking device, etc.), which is connected to or even incorporates the CXL-based switch. Local memory of the network processor device may be utilized to construct a shared memory pool for the cluster, which can be leveraged to facilitate efficient data transfers utilizing CXL, including data transfers between cluster allowing local compute and memory resources to be pooled and flexibly shared among devices in the interconnected clusters. CXL enables a more efficient data transmission than TCP and RDMA between all the processors and accelerators of the cluster. The network processor device may be configured with logic (implemented in hardware, firmware, and/or software) to perform near-data processing for the cluster and reduce the memory movement, to thereby provide more efficient performance in an improved service mesh cluster architecture. Such an architecture can be used to implement data center clusters with reduced memory movement between hosts, lower latency, improved resource utilization, and lower power consumption, among other example benefits.

With CXL-based memory pooling, memory resources of various devices in multiple different platforms may be hosted in a pool and accessed by multiple platforms (e.g., servers in a data center) as part of their physical address spaces. Moreover, in some implementations, certain data within pooled memory may also be shared between devices, including devices in different platforms. Generally, memory pooling in this manner enables total cost of ownership (TCO) savings with cloud-based computing systems and data centers as servers do not need to be over-provisioned for worst case memory capacity requirements, instead, relying on other servers' resources on an as-needed basis. For instance, a platform can leverage pooled memory, for the average case, to “borrow” and “return” memory from the pool when insufficient local memory is available for a particular workload.

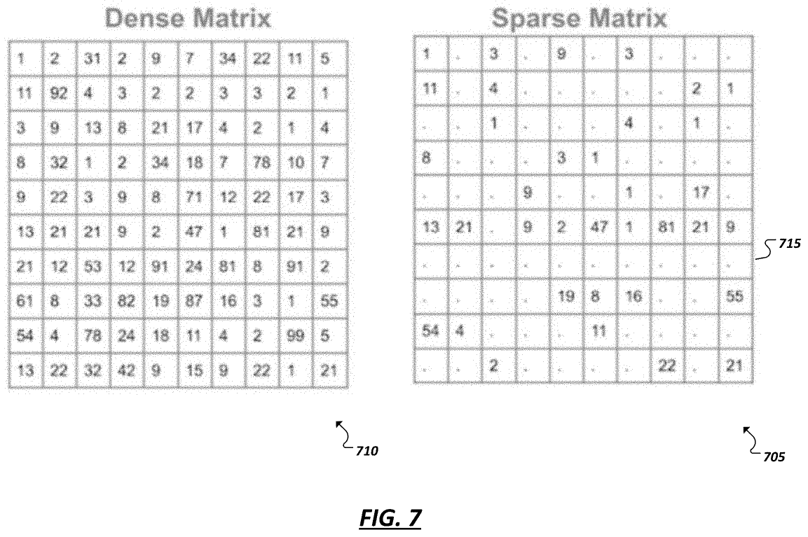

With the growth in AI and machine learning operations, one common set of operations that is growing as a compute use case are operations involving sparse matrices. FIG. 7 is an illustration of the difference between sparse matrices (e.g., 705) and dense matrices (e.g., 710). A sparse matrix (in its uncompressed or unmodified form) has a substantial number of zero values within the matrix (e.g., including at least one row (e.g., 715) of all zeros, whereas dense matrices are made up of mostly nonzero values. In this respect, lines of memory used to store a sparse matrix may include multiple lines with the same common value (e.g., or pattern across a corresponding row or rows within the matric)—all zero. It should be appreciated that solutions discussed herein may also apply to dense matrices or other data structures where lines of data with the same contents, or data pattern, repeat at a statistically significant frequency (e.g., as all-zero data patterns appear in memory used to store sparse matrices), including data patterns that include non-zero values.

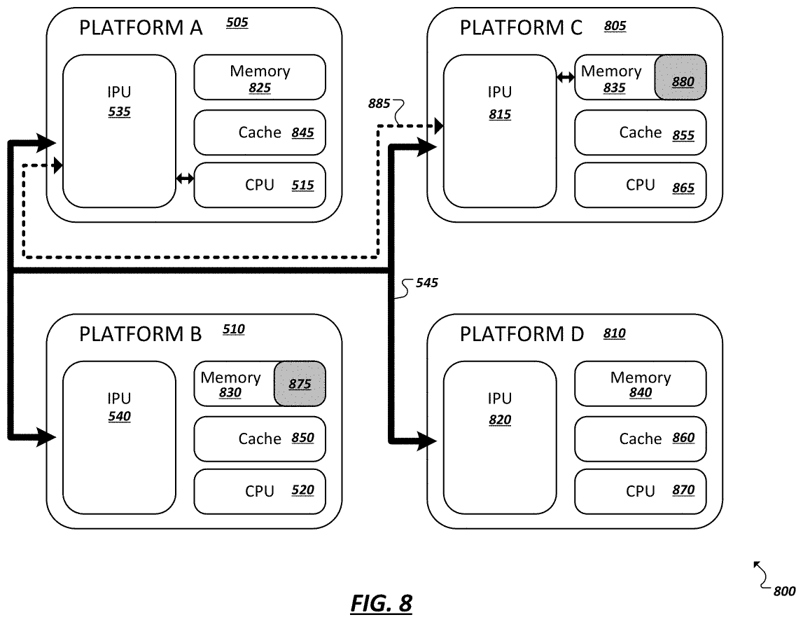

Turning to FIG. 8, a simplified block diagram 800 is shown illustrating an example system that includes multiple computing platforms (also referred to herein as clusters or nodes), such as what could be included within a server system or data center. In this example, the platforms (e.g., 505, 510, 805, 810) are interconnect within the system using respective network processing devices (e.g., 535, 540, 815, 820) which are interconnected through a fabric links 545 communicatively coupling each network processing device 535, 540, 815, 820 to the other. Platforms may include various compute and memory elements, including processor devices (e.g., 515, 520, 865, 870), local cache (e.g., 845, 850, 855, 860), and memory elements (e.g., 825, 830, 835, 840). Memories (e.g., 825, 830, 835, 840) may be implemented as local system memory, memory expansion devices, accelerator-attached memory, among other examples. Indeed, the platforms (e.g., 505, 510, 805, 810) may represent heterogenous systems of varied hardware, functionality, and capabilities. The network processing devices (e.g., 535, 540, 815, 820) may possess CXL protocol stack logic to support CXL connections with devices within their respective platforms and may utilize CXL (or a comparable technology) to implement memory pooling within the system. For instance, portions (e.g., 875, 880) of the memory resources (e.g., 825, 830, 835, 840) within the corresponding platforms (e.g., 505, 510, 805, 810) may be made available for access by other devices on other platforms in the system and thus shared in the memory pool.

Continuing with the example of FIG. 8, with memory pooling configured, a device (e.g., CPU 515) on one platform (e.g., Platform A 505) may consider pooled memory as its own, including memory (e.g., 880) physically present on a remote platform (e.g., Platform C 805). Various policies may be defined governing how and under what conditions remote access may be allowed, but generally, in one example, a device (e.g., 515) requesting access to a portion (e.g., one or more lines) of remote pooled memory (e.g., 880) may initiate the access by sending a request (e.g., using CXL.mem or CXL.cache) to its local network processing device (e.g., 535). The requesting network processing device 535 may identify the network processing device (e.g., 815) of the target platform 805 hosting the lines of memory requested by the requesting device 515. The requesting, or client, network processing device 535 may generate an access request and communicate the request (and receive corresponding responses) over the fabric 545 (e.g., in transaction 885). The target network processing 815 may receive the request (e.g., a CXL request tunneled or nested within the protocol(s) used in the fabric 545) and generate (e.g., convert the access request) or forward the underlying request to the target device (e.g., memory controller) managing the requested memory 835. The memory device 835 may generate a response to the request (e.g., a read return or write completion) and return the response (e.g., data) to the requester by sending the response to its local network processing device 815, which in turn forwards the response through the fabric 545 to the requesting network processing device 535 for ultimate delivery to the requesting compute device 515, among other examples. While additional latency is added through such an architecture, the CXL protocols allow relatively high speed pooled memory transactions that enable excellent architectural flexibility, with applications able to flexibly assemble CXL “networks” and memory pools using a variety of different platforms and their constituent resources.

In some cases, a single program or workload may include repeated accesses (e.g., reads or writes) to a piece of data. In cases where the data is accessed from a data pool and includes a common data pattern, the bandwidth required to access the data (e.g., the bandwidth of the memory subsystem and/or the interconnect(s) coupling platform together in the system implementing the memory pool) may be unduly burdened by such repetitious access transactions involving the pooled memory resources, resulting in inefficiencies in such an architecture. As an example, workloads such a convolutions and machine learning model training may involve repeated accessed to the same matrix or tensor, among other examples. As data volumes grow and compute use cases such as AI and machine learning evolve, architectures are developed in recognition of the increasing demand for memory and interconnect bandwidth, for instance, due to intense operations on small regions of data. For instance, specialized machine learning architectures have been developed which provide for near-processing scratchpad memory to help facilitate a processor's repeated accesses to a particular tensor or other data under operation.

To illustrate the challenge (and opportunity) introduced by sparse matrices or other data with repeating, common data patterns, consider an example situation (e.g., operations with a convolution layer, training of a graphics processor unit (GPU), or another example), where a piece of data is to be accessed multiple times, but the data is stored as multiple cache lines with mostly zeros, or very few non-zero entries. Requesting this data within a memory pool (e.g., CXL memory pool) may result in many identical cache lines being transferred over the interconnect (e.g., CXL bus) and occupying slots in the memory controller queues in the memory pool. Likewise, in cases where a network processing device or switch is used to access such data from a remote memory in the pool in connection with a workload, these accesses may result in several effectively redundant data transfers back and forth within the system, among other example issues. Accordingly, workflows that utilize sparse matrices or other data with repeating values may negatively impact the viability of a memory pool by placing undue pressure on the interconnect and memory subsystem infrastructure used to implement the pool.

Traditional systems attempt to address the issue of sparse matrices and redundant data transfers or memory accesses through local mechanisms (e.g., local scratchpad memory) or conservative policies and algorithms to meet demanding service level agreements (SLAs) within a data center system. In an improved system, a system utilizing network processing devices (e.g., IPUs) and/or switches to facilitate memory pooling (e.g., CXL memory pooling) may be enhanced through the provision and use of probabilistic data structures (and supporting logic), such as Bloom filters (e.g., at the network processing device(s) and/or CXL switches, etc.), to identify attempts to access a data that includes a common data pattern (e.g., all zeros) within a memory pool. For instance, a bloom-filter-based data filter may be provided, such that all-zero data at an address (e.g., within a sparse matrix) may be returned to the requesting device without actually sending the access request to the host of the data (in the case of a read of the data). In this manner, a number of requests for data that would occupy interconnect and memory subsystem bandwidth may be avoided entirely, there by greatly reducing traffic related to common operation and also improving the overall latency of corresponding software applications and services. In some cases, replacing reads to even a small fraction of the most common cache line(s) by end-running actual read transactions based on Bloom filter results may have a multiplying effect (e.g., replacing reads to 1% of memory could reduce overall ready traffic by 20-30% or more, depending on the frequency with which the workload calls on those lines to be read).

In one example implementation, Bloom filters may be constructed by a network processing device (or a CXL switch, in such implementations) to correspond with regions of pooled memory designated as “sparse memory”. The sparse memory may designate a portion of the pooled memory that is to be used to store portions of a matrix (or other quantum of data) that includes values not encompassed by a common data pattern (e.g., all zeros) that is expected be present within the matrix. For instance, software may request an amount of memory it intends for use during operation. The software may also designate an amount of anticipated sparsity of the data. It is intended that regions of memory designated as sparse are the exception, with the memory address space mapped into sparse memory serving as a specialized memory region for use in handling transactions involving sparse data (e.g., in connection with a Bloom filter implementation, such as described herein). The mapping of the memory address space into sparse memory may be configured by the system management software or by the network processing devices of the various interconnected platforms working in concert, among other example implementations.

For instance, the software may indicate a need for 1 TB of memory, but identify an upper bound for sparsity at 10%, meaning that were the repeating common data patterns removed from the data, only 1TB*10%=100 GB of real memory would be needed by the software. Accordingly, rather than reserving 1 TB of pooled memory, a 100 GB sparse memory block (and corresponding address range) may be reserved for the software (and its use of a sparse matrix). A corresponding Bloom filter may also be accessed (if pre-generated) or constructed for use in filtering out requests for lines of data that incorporate the common data pattern. In this manner, the pooled memory system may operate to attempt to only transport requests for remote memory accesses where the Bloom filter is unable to verify that the requested line of memory does not include the common data pattern. Where the Bloom filter confirms that the requested line contains nothing but the common data pattern, rather than forwarding the read request, the device (e.g., IPU, data processing unit (DPU), pooled memory controller, switch, etc.) hosting or implementing the Bloom filter may short circuit the read request and simply send the common data values back as a response without incurring additional traffic for the read.

In some cases, a sparse matrix may be both read from and written to during the execution of workload. To handle reads, as introduced above, a Bloom filter may be provided and configured for use in identifying if a given region of pooled memory being accessed by a particular read will be composed simply of a corresponding common data pattern (e.g., all zeros or another commonly reused data pattern) or not. For example, an address @A (e.g., address tag) may be provided as an input to the Bloom filter and the Bloom filter may return a result that indicates whether a corresponding memory line at @A (e.g., a 64 B line, a 1 KB range, etc.) is all zeros or not. A hit on the Bloom filter indicates that the memory address only includes the common data pattern. If the Bloom filter does not return a hit, this could mean that the contents are unknown to the Bloom filter or that the Bloom filter can confirm that data other than the common data pattern are present in that address. Accordingly, a miss may cause the network processing device or switch to form an access request to send over the interconnect coupling two platforms and allow the read to be carried out on the sparse memory region. In some cases, a miss may be returned even when the targeted line of memory contains the common data pattern. When such reads occur and the results returned, the Bloom filter management logic may update the Bloom filter to reflect this. Similarly, if a write to a line in sparse memory changes its contents such that it now includes the common data pattern, this write may be detected and result in the Bloom filter being updated, among other examples.

In some implementations, the host of the Bloom filter may track hits and misses, as well as the corresponding addresses corresponding to the hits and misses. Other tracking mechanisms may be deployed, for instance, to maintain and update the Bloom filter, as well as coordinate consistency between multiple instances of a Bloom filter (e.g., where the sparse memory block is to be shared between multiple platforms (and respective copies of the Bloom filter maintained by the respective network processing device in each platform). A fast lookup structure may be employed to facilitate such tracking. In one example, content addressable memory (CAM) may be utilized in association with such tracking (although alternative technology may be used in other implementations). In one example, a network processing device of a platform, node, or cluster hosting a portion of the sparse memory block may manage a CAM structure that is indexed using memory address tags. For instance, in the case of a hit on a given memory tag input to the CAM, the CAM returns the real physical address in the target platform (e.g., @A′ where @A) where the requested line of data is stored and the operation (e.g., read or write) will be performed. In case of a miss on a read request, the CAM may thereby indicate that the line was zeros, never written to, and is not stored in memory (e.g., DIMMS). In such a case, a read (that initially passed the Bloom filter of the requesting node) will return a 0, which is sent back in response to the requesting node. In the case of write request miss at the CAM, where the payload to be written is not the common data pattern (e.g., not all zeros), this indicates to the memory controller managing this address that a new physical line is to be assigned, with the write performed to that new line. The real address of this new line is then associated with the address tag in the request in the CAM structure, and so on. The number of entries on the CAM that can be used by a given application (represented by its processed address ID included in the access request received at the IPU) is limited to what was requested for the size of the sparse memory block. In case that write for a given application overpasses the requested amount of memory in sparse mode, the memory controller may generate a software interrupt or other error to indicate that the software has violated the terms of the requested sparse memory block, among other example features and implementations.

As introduced above, in some implementations, a sparse memory region implemented in a pool may be shared between multiple devices or platforms within the system. To preserve consistency, each platform may have a copy of the Bloom filter generated for the sparse memory region. Additionally, the platforms (e.g., through their respective network processing devices) may cooperate to maintain consistency of the Bloom filters. For instance, to accomplish such sharing, memory ranges and addressing may be configured to be consistent across the multiple platforms before operation. Additionally, when a given memory link is written to by any one of the platforms, the platforms may notify the others such that each platform's Bloom filter is updated accordingly.

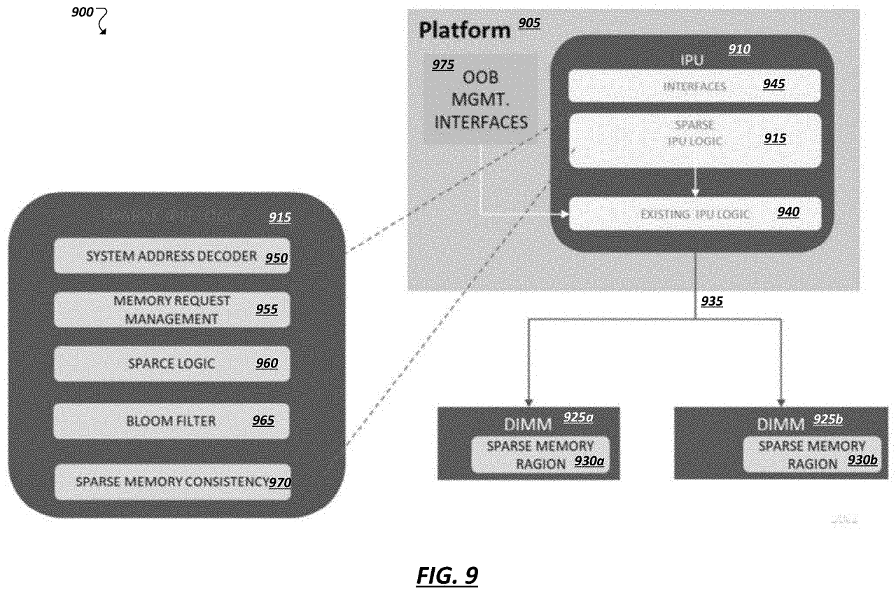

FIG. 9 is a simplified block diagram 900 illustrating components of an improved example network processing device 910 for a platform 905 capable of using sparse memory regions in connection with Bloom filter logic to handle sparse or repetitive data. The example network processing device 910 may include network processing logic 940 to implement a network processing device such as discussed above, as well as interfaces 945 to couple to local devices within the platform 905, as well as external interfaces to couple to other network processing devices or switches interconnecting platforms in the system. An example network processing device may be enhanced to include sparse processing logic (e.g., 915), implemented hardware circuitry, firmware, or software, to effectively utilize sparse memory regions, such as introduced above.

In one example implementations, sparse processing logic 915 may include a variety of functionality components or hardware logic to implement and support functions of the engaged network processing device. For instance, in order for the network processing device 910 to support requests to a sparse memory region designated in pooled memory, the sparse processing logic 915 may include a system address decoder 950, memory request manager 955, sparse memory manager 960, Bloom filter(s) 965, and sparse memory consistency manager 970, among other example logical and/or functional components. In one example implementation, the system address decoder 950 may determine, from addresses identified in a local request, the corresponding address (and host platform) in physical memory, among other example functions. Memory request manager 955 may service requests received from other network processing devices of other platforms and may base the servicing of these requests on whether the request is directed to sparse memory or another region of memory. Sparse memory manager 960 may be utilized to manage the configuration and designation of sparse memory ranges (e.g., the size of the range, the sparsity levels expected, quality of service conditions, etc.), as well as the allocation of the sparse memory range to various processes (and devices executing these processes, including those hosted on remote platforms). The Bloom filter 965 can incorporate Bloom filters created and maintained to correspond to various sparse memory regions designated within a memory pool as well as the logic for creating, updating, and managing such Bloom filters. Sparse memory consistency manager 970 may be used in conjunction with Bloom filter logic 965 to maintain consistency in instances where a sparse memory region is shared between multiple processes and/or platforms, among other example functionality. It should be appreciated that the components of the sparse processing logic illustrated in these examples are for illustrative purposes only. Indeed, the functionality described herein may be implemented using alternative components, including subdivisions or combinations of the components described in this example, to implement an enhanced network processing device, pooled memory controller, or CXL switch capable of handling requests to sparse memory in an optimized manner, such as discussed herein.

One or more memory resources may be provided locally within the platform 905. For instance, DIMM memory resources (e.g., 925a-b) may be provided through which the network processing device 910 may communicate through its interfaces 945 (e.g., via CXL-compliant links (e.g., 935)). Sparse memory regions (e.g., 930a-b) may be configured, by direction of software (associated with sparse data), in portions of the memory resources 925a-b. The sparse memory regions may be flexibly set up and torn down as needed and as appropriate by software. Further corresponding Bloom filters may be constructed (e.g., by Bloom filter logic 965) in connection with the provisioning of sparse memory regions in memory resources of the platform. System software, out-of-band system managers, or other system management logic (e.g., 975) may interface with the network processing device 910 (and other components of the platform 905) to provide information for use in configuring sparse memory regions among other support in connection with the use of sparse memory regions and corresponding Bloom filters in some implementations.

Continuing with the example of FIG. 9, to enable a requesting platform, through its network processing device, to utilize a sparse memory region on a remote node, remote memory pool or remote device, the network processing device may draw upon several features of its sparse processing logic 915. The network processing device may interface with the software stack in order to allocate and manage a newly designated sparse memory region. The sparse memory manager 960 may be configured by software (e.g., BIOS, OOB or similar mechanism (e.g., 975) to identify the size of the region devoted to sparse memory. This interface may indicate to software and/or memory controllers of the physical memory being designated as sparse memory such information as the amount or percentage of memory is to be devoted for sparse memory and the maximum amount that individual applications, services, microservices, or workloads can allocate for this type of memory. In some instances, the maximum range of memory that can be designated as sparse memory may be limited by the tracking capabilities of the server platform (e.g., the size of the CAM of the corresponding memory controllers, among other examples). Further, in the case where multiple platforms share the sparse memory range, system software (or the participating network processing devices) may further orchestrate coordination in configuring the shared memory range and attributes, as well as the supporting Bloom filter structures used by the multiple sharing platforms, among other example features.

In some implementations, one or more interfaces or instruction set architecture (ISA) instructions may be defined to allow a software-based controller (e.g., BIOS, operating system (OS) on behalf of a given workload, etc.) to allocate a given amount of memory into a region of sparse memory. Such interfaces may be utilized by software to define the amount of required memory, the range of expected sparsity, the virtual address range that is to be mapped into the sparse memory range, and an identification of the process(es) that will be requesting/using the allocated memory, among other example information. As it pertains to the definition of address ranges to be mapped onto the shared memory, software is to identify whether one or more multiple platforms are using the allocated shared memory and may ensure, in the case of sharing by multiple platforms, that a consistent memory address state is defined for the shared sparse memory allocation, among other example considerations.

Size and sparsity limits configured for sparse memory may be monitored at the memory controller(s) corresponding to the memory and a particular software interrupt may be defined, which may be invoked by a memory controller when an overflow of a particular sparse memory address range is registered. For instance, such a software interrupt can be provided to an OS or to a particular process (e.g., indicated by its process address space ID (PASID)) and identify an address range base address corresponding to the failure and a process ID associated with the range, together with the size associated with the sparse memory range. The interrupt-based notification comes from the target memory node, but the process likely executes on a requesting platform, resulting in the use of the requesting platform's network processing device to assist in notifying the offending process of the overflow. In some cases, depending on where the software interrupt is handled, a corresponding OS may expose mechanisms to retrieve the VA for a particular PA in order to know what address range caused the failure, among other example features and implementations.

As introduced above, a network processing device at a platform requesting access to data in sparse memory may construct, manage, and utilize a Bloom filter (using Bloom filter manager 965) corresponding to the sparse memory range to thereby optimize access to sparse memory. The network processing device may use the Bloom filter(s) to identify true positives of memory ranges that include a given common data pattern (e.g., all zeros). As already discussed in the summary section, the IPU will have a Bloom filter that is used to identify if a given region being accessed from a particular read will have zeros or not. A memory request manager 955 may identify requests received from devices in the platform 905 and utilize system address decoder 950 to identify that a request is for data in a sparse memory block. The system address decoder 950 may also identify the physical locate (e.g., on a remote platform) of the requested line of sparse memory, allowing the network processing device (e.g., 910) to identify which other network processing device of the target platform to communicate with to complete the transaction. However, in cases, where the network processing device 910 identifies that a request corresponds to a sparse memory region, the network processing device 910 may utilize the corresponding Bloom filter to determine whether the requested line merely includes a common data pattern. If the Bloom filter returns a hit, rather than passing the request forward to the target network processing device, the network processing device 910 of the requesting platform may instead return a response directly to the requesting device in the platform 905 by generating a synthetic response that includes the common data pattern as a response to the request. In cases where the Bloom filter returns a miss, however, the network processing device 910 may generate a version of the request (e.g., CXL encapsulated in Ethernet, etc.) to forward over the fabric interconnecting the platforms to the network processing device of the target memory resource, to be handled as a tradition memory transaction involving remote memory in a CXL memory pool.

As noted above, in cases where sparse memory is shared among multiple platforms or nodes, multiple instances of a corresponding Bloom filter may be maintained for each platform. For instance, depending on the level of hierarchy and the type of memory consistency being implemented (e.g., MESI, MESIF etc.) the Bloom filters may be shared among multiple cores to avoid false positives. Sparse memory consistency manager 970 may be utilized to identify and implement updates to the Bloom filters and Bloom filter logic based on reported transactions from other platforms involving the sparse memory.

In cases where a platform (e.g., 905) hosts memory resources (e.g., 925a-b) with regions of sparse memory (e.g., 930a-b), the network processing device (e.g., 910) of the platform may track writes to the shared memory, for instance, using a CAM. A system address decoder 950 may be used to identify, from the address included in an incoming request (received from a requesting platform's network processing device), whether the request is directed to a portion of physical memory mapped to the sparse memory range (and is to be processed accordingly), or whether the request is directed to other memory ranges and may be processed conventionally. In the case of requests to a sparse memory range, a CAM or other data structure may be utilized to determine the response to the request. For instance, the CAM may be utilized to identify the lines of sparse memory already written to, as well as identify lines that are unwritten, among other information (such as discussed above).

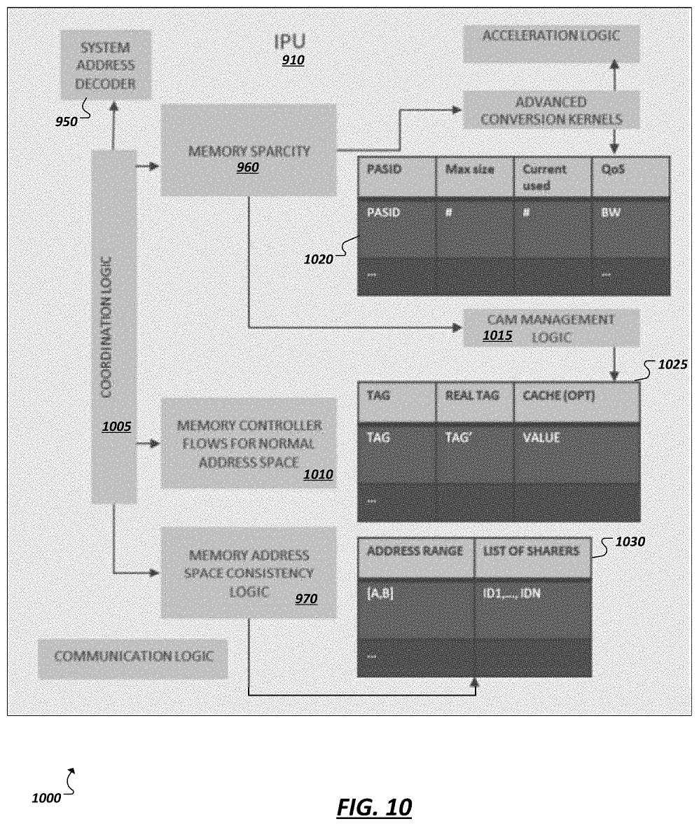

FIG. 10 is a simplified block diagram 1000 illustrating additional details of an example network processing device 910, such as an IPU, provided with sparse processing logic (e.g., implemented in hardware circuitry of the network processing device). Coordination logic 1005 may be utilized to route requests for processing in the network processing device based on the address targeted by the requests and decoded using system address decoder 950. If the address is included in a sparse memory range, the coordination logic 1005 route the request for conventional processing using memory controller logic 1010. If the address maps to sparse memory, sparse memory manager 960 may be used. Accordingly, in such instances, the sparse memory manager 960 may utilize data structures (e.g., 1020, 1025, 1030), such as registers, to manage proper access and request processing of the sparse memory. For instance, a CAM 1025 may be provided and managed by CAM management logic 1015. Further, the allocation and configuration of sparse memory may be maintained to track processes to which portions of the sparse memory are allocated, the maximum size and sparsity of the allocation, any quality of service (QoS) requirements, among other example information. Further, sparse memory consistency logic 970 may be utilized to track (using data structure 1030) the client platforms or devices sharing an allocation (e.g., address range) of sparse memory, in the case of a shared allocation of memory, among other example features.

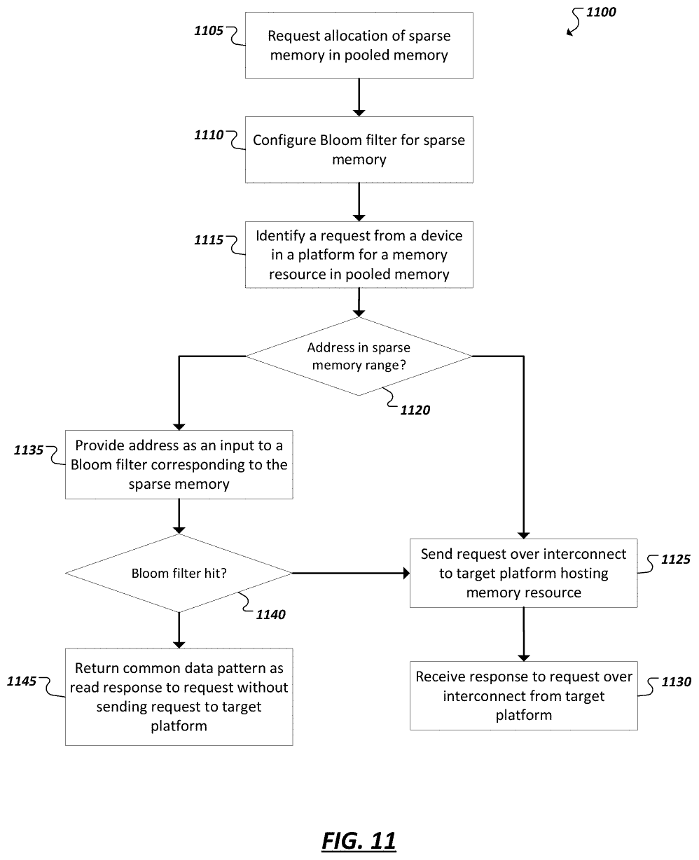

Turning to FIG. 11, a simplified flow diagram 1100 is shown illustrating an example technique for accessing a portion of pooled memory designated for use as a sparse memory region. In one example, allocation of a portion of the sparse memory region may be requested 1105. The use of the sparse memory region may be requested, for instance, by system software, an application running on a platform, or using logic of the network processing device used to connect the platform to other platforms in the system (e.g., a data center). The allocation may request an amount of the overall sparse memory region for use, an indication of the maximum sparsity of data to be anticipated, a quality of service standard for the use, an indication of whether other platforms may share the allocation, among other example information. Requests on the allocated sparse memory region may be generated by a requesting device on a requesting platform. The network processing device handling requests for the requesting platform may configure 1110 a Bloom filter for use in connection with the sparse memory region, among other logic and data structures for use in handling requests involving sparse memory (e.g., registers or other data structures to track whether other platforms are sharing access to the sparse memory region, etc.).

Continuing with the example of FIG. 11, a request for a line of memory may be generated by the requesting device and forwarded to the network processing device to be routed to the target platform whereon the physical memory implementing the sparse memory region is located. The network processing device may identify 1115 the request and the address of the pooled memory requested. The network processing device 1115 may decode the address to determine 1120 whether the request is directed to a sparse memory region. If the address is directed to a portion of pooled memory other than sparse memory, the network processing device can handle the request as it would other conventional requests to pooled memory, for instance, by identifying the target platform whereon the requested physical memory is located and forwarding 1125 the request to the target network processing device of the target platform. In response, the target network processing device may forward a response generated by the target memory subsystem to the request. This response is received 1130 from the target network processing device at the requesting network processing device. The requesting network processing device then prepares the response for delivery to the requesting device and sends the response to the requesting device (e.g., via a CXL link coupling the requesting device to the network processing device).

As introduced above, in cases where the network processing device identifies (at 1120) that a request on pooled memory is directed to a sparse memory region, the network processing device may attempt to fulfill the request itself and avoid introducing additional traffic on the fabric interconnecting the platforms or to the memory controller(s) governing the sparse memory region. The network processing device may provide the address of the request to a Bloom filter (at 1135) corresponding to the sparse memory region. The Bloom filter may be configured to determine (at 1140) whether a common data pattern (predicted to likely appear in several lines of the sparse memory) occupies the requested line of memory at the address. In the event of a “hit” at the Bloom filter, the Bloom filter confirms that the requested line of memory is known to contain data of the common data pattern. In the event of a miss, the Bloom filter is unable to verify that the requested line contains the common data pattern. As such, when a Bloom filter hit is confirmed, the network processing device may generate a response for the requesting device that include the common data pattern as its payload and skip the forwarding of the request to the target platform and memory controller to save bandwidth. Alternatively, in the event of a Bloom filter miss, the network processing device may proceed with causing the request to be handled as other requests on remote pooled memory, for instance, by sending the request over the fabric to the target network processing device of the target platform for handling by the memory subsystem associated with that address. A request generated at the target platform may be received 1130 in response and provided to the requesting device by the requesting platform's network processing device.

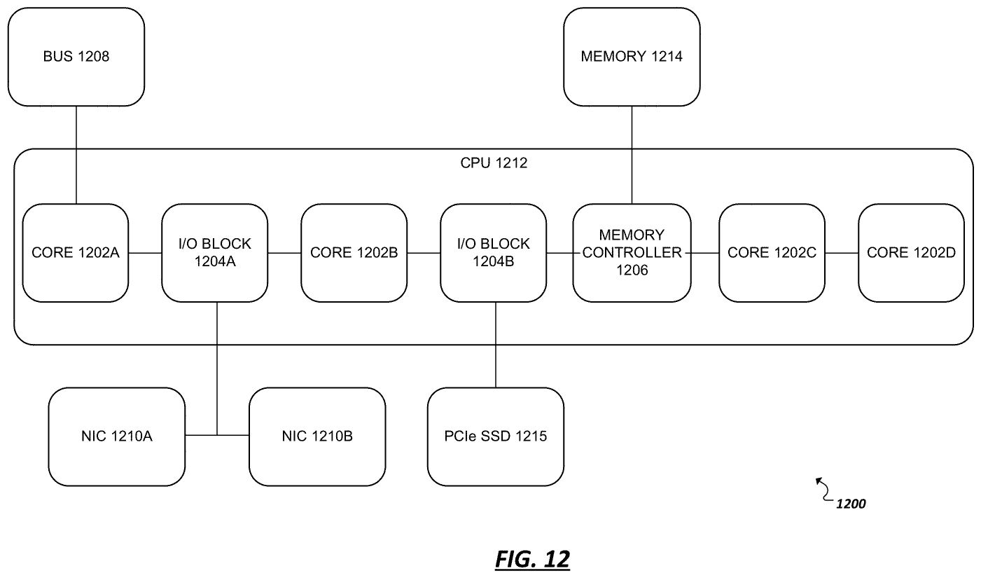

Note that the apparatus', methods', and systems described above may be implemented in any electronic device or system as aforementioned. As a specific illustration, FIG. 12 provides an exemplary implementation of a processing device such as one that may be included in a network processing device. It should be appreciated that other processor architectures may be provided to implement the functionality and processing of requests by an example network processing device, including the implementation of the example network processing device components and functionality discussed above. Further, while the examples discussed above focus on the use of CXL and CXL-based resource pooling, it should be appreciated that reference to CXL is as an illustrative example only. Indeed, the more generalized concepts disclosed herein may be equally and advantageously applied to other interconnects and interconnect protocols that facilitate similar resource pooling, among other examples.

Referring to FIG. 12, a block diagram 1200 is shown of an example data processor device (e.g., a central processing unit (CPU)) 1212 coupled to various other components of a platform in accordance with certain embodiments. Although CPU 1212 depicts a particular configuration, the cores and other components of CPU 1212 may be arranged in any suitable manner. CPU 1212 may comprise any processor or processing device, such as a microprocessor, an embedded processor, a digital signal processor (DSP), a network processor, an application processor, a co-processor, a system on a chip (SOC), or other device to execute code. CPU 1212, in the depicted embodiment, includes four processing elements (cores 1202 in the depicted embodiment), which may include asymmetric processing elements or symmetric processing elements. However, CPU 1212 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1212, as illustrated in FIG. 12, includes four cores—cores 1202A, 1202B, 1202C, and 1202D, though a CPU may include any suitable number of cores. Here, cores 1202 may be considered symmetric cores. In another embodiment, cores may include one or more out-of-order processor cores or one or more in-order processor cores. However, cores 1202 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1202 may include a decode module coupled to a fetch unit to decode fetched elements. Fetch logic, in one embodiment, includes individual sequencers associated with thread slots of cores 1202. Usually a core 1202 is associated with a first ISA, which defines/specifies instructions executable on core 1202. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1202 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1202, in one embodiment, recognize the same ISA (or a subset thereof). Alternatively, in a heterogeneous core environment, a decoder of one or more cores (e.g., core 1202B) may recognize a second ISA (either a subset of the first ISA or a distinct ISA).

In various embodiments, cores 1202 may also include one or more arithmetic logic units (ALUs), floating point units (FPUs), caches, instruction pipelines, interrupt handling hardware, registers, or other suitable hardware to facilitate the operations of the cores 1202.

Bus 1208 may represent any suitable interconnect coupled to CPU 1212. In one example, bus 1208 may couple CPU 1212 to another CPU of platform logic (e.g., via UPI). I/O blocks 1204 represents interfacing logic to couple I/O devices 1210 and 1215 to cores of CPU 1212. In various embodiments, an I/O block 1204 may include an I/O controller that is integrated onto the same package as cores 1202 or may simply include interfacing logic to couple to an I/O controller that is located off-chip. As one example, I/O blocks 1204 may include PCIe interfacing logic. Similarly, memory controller 1206 represents interfacing logic to couple memory 1214 to cores of CPU 1212. In various embodiments, memory controller 1206 is integrated onto the same package as cores 1202. In alternative embodiments, a memory controller could be located off chip.

As various examples, in the embodiment depicted, core 1202A may have a relatively high bandwidth and lower latency to devices coupled to bus 1208 (e.g., other CPUs 1212) and to NICs 1210, but a relatively low bandwidth and higher latency to memory 1214 or core 1202D. Core 1202B may have relatively high bandwidths and low latency to both NICs 1210 and PCIe solid state drive (SSD) 1215 and moderate bandwidths and latencies to devices coupled to bus 1208 and core 1202D. Core 1202C would have relatively high bandwidths and low latencies to memory 1214 and core 1202D. Finally, core 1202D would have a relatively high bandwidth and low latency to core 1202C, but relatively low bandwidths and high latencies to NICs 1210, core 1202A, and devices coupled to bus 1208.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a set of first ports to couple to a set of devices in a first computing node; a second port to couple to a second computing node, where the second computing node hosts a memory resource and the memory resource is to be included in a memory pool, where the memory pool allows access to the memory resource by remote computing nodes; circuitry to: identify a first request by a particular device in the set of devices to access a first line of memory in the memory resource, where the first line is associated with a first address; determine that the first address corresponds to a particular memory region in the memory pool; provide the first address as an input to a probabilistic data structure, such as a Bloom filter, based on the first request directed to the particular memory region, where the Bloom filter is to generate a result to identify whether the first line of memory includes a common data pattern; and return the common data pattern to the particular device as a response to the first request based on the result of the Bloom filter, where the result of the Bloom filter indicates that the first line of memory includes the common data pattern.

Example 2 includes the subject matter of example 1, where the first request is not forwarded to the second computing node based on the result of the Bloom filter.

Example 3 includes the subject matter of any one of examples 1-2, where the circuitry is further to: identify a second request to access a second line of memory in the memory resource, where the second line is associated with a second address; provide the second address as an input to the Bloom filter to generate a second result; and send the second request to the second computing node based on the second result, where the second result does not indicate that the second line of memory includes the common data pattern.

Example 4 includes the subject matter of any one of examples 1-3, where the particular memory region includes memory designated as a sparse memory region, where the Bloom filter is used to determine whether the first line of memory includes the common data pattern based on the association of the first address with the sparse memory region.

Example 5 includes the subject matter of any one of examples 1-4, where the Bloom filter is associated with the particular memory region and the particular memory region is shared by a plurality of devices in the plurality of computing nodes.

Example 6 includes the subject matter of example 5, where the circuitry is further to: identify data written to a particular line of memory in the particular memory region; and update the Bloom filter based on the data written to the particular line of memory.

Example 7 includes the subject matter of any one of examples 1-6, further including: a network processing device including: a processor; the set of first ports; the second port; and the circuitry.

Example 8 includes the subject matter of any one of examples 1-7, where the set of first ports are each compatible with a particular interconnect protocol, the particular interconnect protocol includes a plurality of sub-protocols, and the plurality of sub-protocols may be multiplexed on each of the set of first ports, and the plurality of sub-protocols includes an I/O protocol, a memory protocol, and a cache coherent protocol.

Example 9 includes the subject matter of example 8, where the particular interconnect protocol includes a Compute Express Link (CXL) protocol.

Example 10 includes the subject matter of example 9, further including: a CXL switch including: switching circuitry; the set of first ports; the second port; and the circuitry.

Example 11 includes the subject matter of any one of examples 1-10, where the common data pattern includes all zeros in a sparse matrix.

Example 12 includes the subject matter of any one of examples 1-10, where the common data pattern includes a pattern with at least one non-zero bit.

Example 13 is a method including: receiving a request, at a first network processing device of a first platform, where the request is received from a first process executed on the first platform and is directed to a particular address; determining that the particular address references a line of memory associated with a sparse memory region defined in a memory pool, where the sparse memory region is physically hosted on a second platform; providing the particular address as an input to a Bloom filter corresponding to the sparse memory region based on determining that the particular address references the sparse memory region; determining from the output of the Bloom filter that the line of memory pool includes a common data pattern; and returning the common data pattern, from the first network processing device to the first process, as a response to the request, without forwarding the request to the second platform.

Example 14 includes the subject matter of example 13, further including: identifying data written to the sparse memory region; modifying the Bloom filter based on the data written to the sparse memory region.

Example 15 includes the subject matter of example 14, where the data is written to the sparse memory region by a second process executed on a third platform, and the sparse memory region includes shared memory.

Example 16 includes the subject matter of any one of examples 13-15, where the memory pool includes a CXL memory pool.

Example 17 includes the subject matter of any one of examples 13-16, where the common data pattern includes all zeros in a sparse matrix.

Example 18 includes the subject matter of any one of examples 13-16, where the common data pattern includes a pattern with at least one non-zero bit.

Example 19 includes the subject matter of any one of example 13-17, further including configuring the sparse memory region.

Example 20 includes the subject matter of example 19, where configuring the sparse memory region includes defining a size and sparsity level for the sparse memory region.

Example 21 includes the subject matter of any one of examples 13-20, where the first process corresponds to convolution of a matrix and the matrix is stored at least partially in the sparse memory region.

Example 22 includes the subject matter of example 21, where only non-zero portions of the matrix are stored in the sparse memory region.

Example 23 is a system including means to perform the method of any one of examples 13-22.

Example 24 includes the subject matter of example 23, where the means include a computer readable storage medium with instructions stored thereon, the instructions executable by a processor to cause the processor to perform at least a portion of any one of examples 13-22.

Example 25 is a method including: receiving a request, at a first network processing device of a first computing cluster, from a second network processing device of a second computing cluster, where the request is directed to pooled memory for a system including the first computing cluster and the second computing cluster; determining that the request corresponds to a line of data mapped to sparse memory implemented in the pooled memory in the first computing cluster, where the request identifies an address tag; providing the address tag to a content addressable memory (CAM) structure corresponding to the sparse memory to determine whether the line of data is written to in the sparse memory implemented in the first computing cluster; generating a response to the request based on results of the CAM structure; and sending the response from the first network processing device to the second network processing device of the second computing cluster.

Example 26 includes the subject matter of example 25, where the pooled memory is implemented using CXL.

Example 27 includes the subject matter of any one of examples 25-26, where the second network processing device includes the apparatus of any one of examples 1-12.

Example 28 is a system including means to perform the method of any one of examples 25-28.

Example 29 includes the subject matter of example 28, where the means include a computer readable storage medium with instructions stored thereon, the instructions executable by a processor to cause the processor to perform at least a portion of any one of examples 25-28.

Example 30 is a system including: a first node including: a memory; a memory controller; and a first network processing device coupled to the memory controller by a first interconnect; a second node including: computing circuitry to execute a process; a second network processing device coupled to the first network processing device by a second interconnect and coupled to the computing circuitry by a third interconnect, the second network processing device including: a Bloom filter; and circuitry to: identify a first request by the process to access a first line of memory in the memory, where the first request references the first line of memory by a first address; determine that the first address corresponds to a sparse memory region in a memory pool; provide the first address as an input to the Bloom filter based on the determination that the first address references the sparse memory region, where the Bloom filter is to generate a result to identify whether the first line of memory includes a common data pattern; and return the common data pattern to the particular device as a response to the first request based on the result of the Bloom filter, where the result of the Bloom filter indicates that the first line of memory includes the common data pattern.

Example 31 includes the subject matter of example 30, further including a third node to execute a second process, where the sparse memory region is shared between the first process and the second process, and a third network processing device of the third node also maintains an instance of the Bloom filter based on sharing the sparse memory region.

Example 32 includes the subject matter of any one of examples 30-31, where the memory pool is implemented to include memory of a plurality of nodes including the first node, and the second node is permitted access to the memory pool.

Example 33 includes the subject matter of any one of examples 30-32, where the first interconnect and the third interconnect are compliant with a CXL-based protocol.

Example 34 includes the subject matter of example 33, where the second interconnect is compliant with a different, non-CXL protocol.

Example 35 includes the subject matter of any one of examples 30-34, where the first and second node include respective computing clusters in a data center.

Example 36 includes the subject matter of any one of examples 30-35, where the common data pattern includes all zeros in a sparse matrix.

Example 37 includes the subject matter of any one of examples 30-35, where the common data pattern includes a pattern with at least one non-zero bit.

Example 38 includes the subject matter of any one of examples 30-37, where the first request is not forwarded to the second node based on the result of the Bloom filter.

Example 39 includes the subject matter of any one of examples 30-38, where the first node is to maintain a content addressable memory (CAM) corresponding to the sparse memory region to track data written to the sparse memory region.

Example 40 includes the subject matter of any one of examples 30-39, where the sparse memory region is used to store a matrix and only non-zero values of the matrix are to be stored in the sparse memory region.

Example 41 includes the subject matter of any one of examples 30-40, further including system software executable to configure the sparse memory region within the memory pool.

Example 42 includes the subject matter of any one of examples 30-41, where the memory pool includes a CXL memory pool.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a set of first ports to couple to a set of devices in a first computing node;
a second port to couple to a second computing node, wherein the second computing node hosts a memory resource and the memory resource is to be included in a memory pool, wherein the memory pool allows access to the memory resource by remote computing nodes;
circuitry to:
identify a first request by a particular device in the set of devices to access a first line of memory in the memory resource, wherein the first line is associated with a first address;
determine that the first address corresponds to a particular memory region in the memory pool;
provide the first address as an input to a probabilistic data structure based on the first request directed to the particular memory region, wherein the probabilistic data structure is to generate a result to identify whether the first line of memory comprises a common data pattern; and
return the common data pattern to the particular device as a response to the first request based on the result of the probabilistic data structure , wherein the result of the probabilistic data structure indicates that the first line of memory comprises the common data pattern.

2. The apparatus of claim 1, wherein the probabilistic data structure comprises a Bloom filter.

3. The apparatus of claim 1, wherein the first request is not forwarded to the second computing node based on the result of the probabilistic data structure.

4. The apparatus of claim 1, wherein the circuitry is further to:
identify a second request to access a second line of memory in the memory resource, wherein the second line is associated with a second address;
provide the second address as an input to the probabilistic data structure to generate a second result;
send the second request to the second computing node based on the second result, wherein the second result does not indicate that the second line of memory comprises the common data pattern.

5. The apparatus of claim 1, wherein the particular memory region comprises memory designated as a sparse memory region, wherein the probabilistic data structure is used to determine whether the first line of memory comprises the common data pattern based on the association of the first address with the sparse memory region.

6. The apparatus of claim 1, wherein the probabilistic data structure is associated with the particular memory region and the particular memory region is shared by a plurality of devices in the plurality of computing nodes.

7. The apparatus of claim 6, wherein the circuitry is further to:
identify data written to a particular line of memory in the particular memory region; and
update the probabilistic data structure based on the data written to the particular line of memory.

8. The apparatus of claim 1, further comprising:
a network processing device comprising:
a processor;
the set of first ports;
the second port; and
the circuitry.

9. The apparatus of claim 1, wherein the set of first ports are each compatible with a particular interconnect protocol, the particular interconnect protocol comprises a plurality of sub-protocols, and the plurality of sub-protocols may be multiplexed on each of the set of first ports, and the plurality of sub-protocols comprises an I/O protocol, a memory protocol, and a cache coherent protocol.

10. The apparatus of claim 9, wherein the particular interconnect protocol comprises a Compute Express Link (CXL) protocol.

11. The apparatus of claim 10, further comprising:
a CXL switch comprising:
switching circuitry;
the set of first ports;
the second port; and
the circuitry.

12. The apparatus of claim 1, wherein the common data pattern comprises all zeros in a sparse matrix.

13. The apparatus of claim 1, wherein the common data pattern comprises a pattern with at least one non-zero value.

14. A method comprising:
receiving a request, at a first network processing device of a first platform, wherein the request is received from a first process executed on the first platform and is directed to a particular address;
determining that the particular address references a line of memory associated with a sparse memory region defined in a memory pool, wherein the sparse memory region is physically hosted on a second platform;
providing the particular address as an input to a Bloom filter corresponding to the sparse memory region based on determining that the particular address references the sparse memory region;
determining from the output of the Bloom filter that the line of memory pool comprises a common data pattern; and
returning the common data pattern, from the first network processing device to the first process, as a response to the request, without forwarding the request to the second platform.

15. The method of claim 14, further comprising:
identifying data written to the sparse memory region;
modifying the Bloom filter based on the data written to the sparse memory region.

16. The method of claim 15, wherein the data is written to the sparse memory region by a second process executed on a third platform, and the sparse memory region comprises shared memory.

17. The method of claim 14, wherein the memory pool comprises a CXL memory pool.

18. A system comprising:
a first node comprising:
a memory;
a memory controller; and
a first network processing device coupled to the memory controller by a first interconnect;
a second node comprising:
computing circuitry to execute a process;
a second network processing device coupled to the first network processing device by a second interconnect and coupled to the computing circuitry by a third interconnect, the second network processing device comprising:
a Bloom filter; and
circuitry to:
identify a first request by the process to access a first line of memory in the memory, wherein the first request references the first line of memory by a first address;
determine that the first address corresponds to a sparse memory region in a memory pool;
provide the first address as an input to the Bloom filter based on the determination that the first address references the sparse memory region, wherein the Bloom filter is to generate a result to identify whether the first line of memory comprises a common data pattern; and
return the common data pattern to the particular device as a response to the first request based on the result of the Bloom filter, wherein the result of the Bloom filter indicates that the first line of memory comprises the common data pattern.

19. The system of claim 18, further comprising a third node to execute a second process, wherein the sparse memory region is shared between the first process and the second process, and a third network processing device of the third node also maintains an instance of the Bloom filter based on sharing the sparse memory region.

20. The system of claim 18, wherein the memory pool is implemented to include memory of a plurality of nodes including the first node, and the second node is permitted access to the memory pool.

21. The system of claim 18, wherein the first interconnect and the third interconnect are compliant with a CXL-based protocol.

22. The system of claim 21, wherein the second interconnect is compliant with a different, non-CXL protocol.
